(19) United States
(12) Patent Application Publication
(10) Pub. No.: US 2026/0113073 A1
(43) Pub. Date: Apr. 23, 2026

(54) NFC DEVICE DETECTION

(71) Applicant: STMicroelectronics International N.V., Geneva (CH)

(72) Inventors: Jean-Marc GRIMAUD, Biot (FR); Nicolas CORDIER, Aix-en-Provence (FR)

(73) Assignee: STMicroelectronics International N.V., Geneva (CH)

(21) Appl. No.: 19/362,772

(22) Filed: Oct. 20, 2025

(30) Foreign Application Priority Data
Oct. 22, 2024 (FR) FR2411516

(51) Int. Cl. H04B 5/70; H04W 4/80

(52) U.S. Cl. CPC H04B 5/70; H04W 4/80

(57) ABSTRACT

A field detector of a near-field communication (NFC)circuit operating in card emulation mode activates a detection signal. The near-field communication circuit is placed in a first state configured to recognize one or more communications issued according to a first NFC standard. A first counter of the NFC circuit is started in response to the activation of the detection signal. When the first counter reaches a first threshold value, the near-field communication circuit is switched to a second state configured to recognize one or more communications issued according to a second NFC standard. When in the first state, the near-field communication circuit is configured to ignore communications issued according to the second NFC standard.

### PRIORITY CLAIM

This application claims the priority benefit of French Application for Patent No. FR2411516, filed on Oct. 22, 2024, the content of which is hereby incorporated by reference in its entirety to the maximum extent allowable by law.

### TECHNICAL FIELD

The present disclosure generally concerns electronic devices incorporating a near-field communication (NFC) circuit, and near-field communication device detection methods.

### BACKGROUND

Electromagnetic transponder communication systems are becoming increasingly common, in particular since the development of near-field communication technologies. These systems typically use a radio frequency electromagnetic field generated by an NFC device (terminal or reader) to detect and then communicate with another NFC device (card) within range.

However, there exist different standards for the generation of fields by a device in reader mode. In particular, modulation and coding characteristics, or also frame start patterns, vary according to standards. A device in card emulation mode is generally configured to detect reader devices according to different standards. However, it is frequent for a device in card emulation mode to miss a request from a reader device. Indeed, frame start patterns having different durations according to the standards followed, a device in card emulation mode can miss a request transmitted by a device transmitting according to a first standard, because it expects the latter to transmit in a second standard.

There is a need to improve the detection of NFC devices.

### SUMMARY

An embodiment provides a method comprising: activating a detection signal by a field detector of a near-field communication circuit, the near-field communication circuit being placed in a first state where it is configured to recognize one or a plurality of communications issued according to a first standard; starting a first counter of the circuit as a response to the activation of the detection signal; and when the first counter reaches a first threshold value, switching the near-field communication circuit to a second state where it is configured to recognize one or a plurality of communications issued according to a second standard, the near-field communication circuit being configured to ignore communications issued according to the second standard when it is in the first state.

According to an embodiment, the first counter is started on a first rising edge of the detection signal transmitted at the starting of the field detector.

According to an embodiment, the above method further comprises, after switching the near-field communication circuit to the second state: starting a second counter; and when the second counter reaches a second threshold value, switching the circuit to the first state or to a third state where the circuit is configured to ignore communications issued according to the second standard.

According to an embodiment, the second counter is started on a first falling edge of the detection signal transmitted by the field detector.

According to an embodiment, the second counter is stopped and reset at each rising edge of the detection signal transmitted by the field detector.

According to an embodiment, communications issued according to the first standard are near-field communications of NFC-A type.

According to an embodiment, communications issued according to the second standard are near-field communications of NFC-B type.

According to an embodiment, the near-field communication circuit is further configured to, when it is placed in the first state, detect near-field communications of NFC-F type.

According to an embodiment, the near-field communication circuit is configured to emulate a plurality of cards.

An embodiment provides a circuit comprising: a field detector, the circuit being configured to be placed in a first state upon activation of a detection signal generated by the field detector, the circuit being further configured to, when placed in the first state, detect one or a plurality of communications issued according to a first standard; and a first counter configured to be started as a result of the activation of the detection signal; the circuit being further configured to be placed in a second state when the first counter reaches a first threshold value, the circuit being configured to, when it is placed in the second state, detect one or a plurality of communications issued according to a second standard, the circuit being configured to ignore communications issued according to the second standard when it is placed in the first state.

According to an embodiment, the above circuit is configured to start the first counter on a first rising edge of the detection signal transmitted at the starting of the field detector.

According to an embodiment, the above circuit is further configured to, when the first counter, or when a second counter, reaches a second threshold value, be placed in the first state or in a third state where the circuit is configured to ignore communications issued according to the second standard.

According to an embodiment, the above circuit is further configured to start the second counter on a first falling edge of the detection signal transmitted by the field detector and to stop and reset the second counter on each rising edge of the signal transmitted by the field detector.

According to an embodiment, communications issued according to the first standard are NFC-A near-field communications, and communications issued according to the second standard are NFC-B near-field communications.

According to an embodiment, the above circuit is configured to emulate a plurality of cards.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an example of a near-field communication system;

FIG. 2 shows, schematically and in the form of blocks, an example of embodiment of a near-field communication device;

FIG. 3A is a timing diagram illustrating an example of a frame start pattern, transmitted by a reader device;

FIG. 3B is a timing diagram illustrating another example of a frame start pattern, transmitted by a reader device;

FIG. 4 is a timing diagram illustrating an example in which a detection of a reader device is missed;

FIG. 5 is a timing diagram illustrating interference in a signal, transmitted by a reader device, interfering in a detection method;

FIG. 6 is a flowchart representing steps of a reader device detection method;

FIG. 7A is a timing diagram illustrating an example of a detection of a reader device; and

FIG. 7B is a timing diagram illustrating an example of a detection of a reader device.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the generation of radio frequency signals and their interpretation have not been detailed, the described embodiments and implementation modes being compatible with usual techniques for generating and interpreting these signals.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

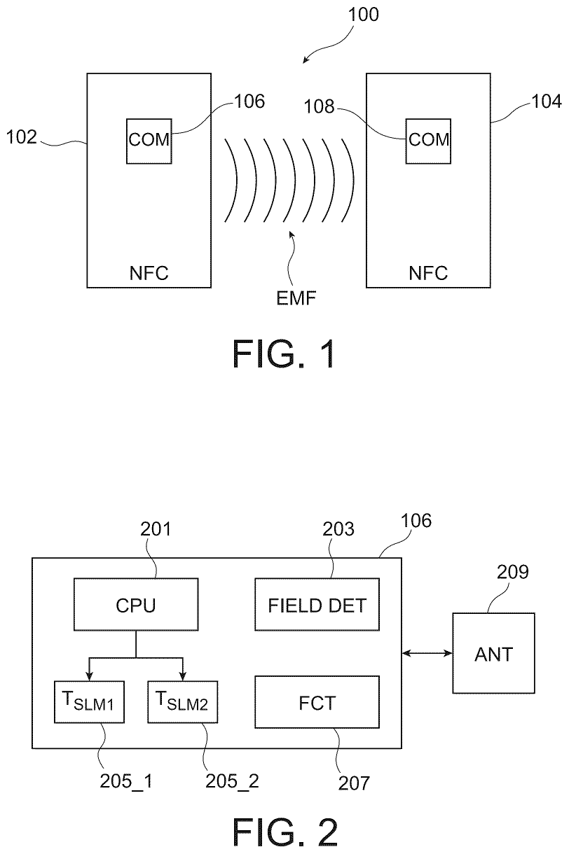

FIG. 1 shows, very schematically and in the form of blocks, an example of a near-field communication system 100 of the type to which apply, as an example, described embodiments and implementation modes.

System 100 comprises a first electronic device 102 and a second electronic device 104. Electronic devices 100 and 102 each comprise, for example, one or a plurality of near-field communication (NFC) circuits. As an example, device 102 is configured to operate in card emulation mode, corresponding, for example, to a mode of emulation of one or a plurality of cards, while device 104 is configured to operate in so-called reader mode.

As an example, device 102 incorporates a near-field communication circuit (COM) 106 comprising at least one electronic element or circuit for generating and detecting a radio frequency signal by means of an antenna (not shown), for example modulation or demodulation circuits. As an example, device 104 incorporates a near-field communication circuit (COM) 108 comprising at least one electronic element or circuit for transmitting and detecting a radio frequency signal by means of an antenna (not shown), for example modulation or demodulation circuits.

On establishing a communication between devices 102 and 104, the radio frequency signal generated by device 104 is detected by device 102 when it is within range. A coupling then forms between two oscillating circuits, in the case in point that of the antenna of device 102 and that of the antenna of device 104. In the case where device 102 is said to be passive, such as, for example, a payment card, the load variation of device 102 is, for example, used to communicate in the direction from card 102 to reader device 104. When device 102 is an active device, for example a telephone, a connected watch, etc., an active charge modulation technique, known to those skilled in the art, is for example used. In particular, active charge modulation is, for example, implemented by device 102 by emitting its own field, synchronized in frequency and phase with the signal transmitted by reader 104 and modulated so as to reproduce a passive load modulation signal. These load variation techniques enable, for example, to decrease the size of the antenna of device 102.

In practice, to establish a communication, device 104 periodically transmits polling frames described according to the various near-field communication standards, for example the ISO14443-A standard, known as NFC-A, the ISO 14443-B standard, known as NFC-B, and the FeliCa standard, known as NFC-F (such standards incorporated herein by reference). When device 102 detects and decodes a polling frame transmitted by device 104, it transmits a response also described by the communication standards. Device 104 then decodes this response and continues the protocol until the card is selected. An application then takes over and application frames, known as Application Protocol Data Units (APDUs), are exchanged, until the deselection of the card, also described in the communications standard. Reader device 104 then switches off its signal.

The NFC-A, NFC-B, and NFC-F standards are standards in which the reader device transmits first (Reader Talk First). The card device is then a slave device and only responds to commands from the reader device. In particular, a reader device is configured, for example, to support a plurality of standards and successively transmit polling frames, for example of NFC-A type, then of NFC-B type, then of NFC-F type, and possibly other technologies afterwards such as, for example, the NFC-V type corresponding to the ISO15693 standard (such standard incorporated herein by reference). Some reader devices are configured so as not to switch off their signal between each polling frame. Other reader devices are configured to switch off their signal between each polling frame in order to consume less energy. This operating mode, known as “polling”, enables the reader device to save energy.

As an example, device 102 is a device having the ability to emulate one or a plurality of cards, such as a cell phone, a connected watch, a remote control, a payment card, etc. Device 104 is, for example, a device transmitting in reader mode, such as an access control device, an electronic lock, a payment terminal, etc.

In practice, the amplitude variations of the field emitted by a reader device, also known as frame start patterns, depend on a NFC standard in which the reader device is configured. Some standards are more widely used than others in certain domains, in certain regions of the world, etc. In some examples, a device in reader mode is configured to transmit a first pattern according to a first standard. In some cases, a second pattern according to a second standard is transmitted if no device in card emulation mode has responded to the transmission of the first pattern.

Device 102 is, in particular, configured to emulate multiple cards to be able to detect different types of patterns and thus respond to different reader devices, transmitting according to different standards.

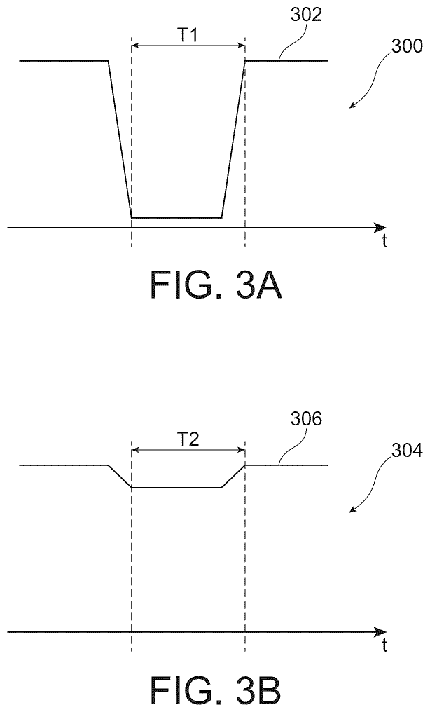

FIG. 2 shows, schematically and in the form of blocks, an example of embodiment of the near-field communication circuit 106 of device 102.

Near-field communication circuit 106 comprises, for example, a computing entity 201 (CPU), for example formed by a processing unit, a microcontroller, a microprocessor, or other processing device configured to execute instructions stored in an instruction memory (not shown in FIG. 2), although it would also be possible for computing entity 201 to be formed by a dedicated circuit, such as a state machine, a programmable logic circuit, etc.

Circuit 106 further comprises, for example, a field detector 203 (FIELD DET). The field detector 203 of device 102 is configured, for example, to detect an electromagnetic field radiated by device 104 when this device is located within range of device 102. As an example, the range of the electromagnetic field radiated by device 104 is in the order of several centimeters, for example smaller than or equal to 50 cm. Field detector 203 is, for example, configured to transmit a detection signal to processing unit 201. As an example, the detection signal transmitted by field detector 203 comprises a rising edge when field detector 203 is activated as a result of the detection of a field radiated by device 104. The signal further comprises a falling edge when field detector 203 is deactivated. When it is activated, field detector 203 is configured to detect modulations in the field emitted by reader device 104.

Near-field communication circuit 106 further comprises a first counter 205_1 (T_{SLM1}) and a second counter 205_2 (T_{SLM2}) controlled by computing entity 201.

Circuit 106 comprises, for example, various other elements or circuits according to the application, for example, a signal generator, analog-to-digital and/or digital-to-analog converters, modulation and/or demodulation circuits, an impedance matching circuit, a filtering circuit, etc. These elements and circuits are symbolized by a single functional block 207 (FCT). Near-field communication circuit 106 further comprises, for example, one or a plurality of volatile storage areas, one or a plurality of non-volatile storage areas, one or a plurality of data, address, and control buses between the various elements internal to circuit 106, as well as one or a plurality of input/output interfaces of communication with the outside of circuit 106.

Circuit 106 is further coupled to a radio frequency signal transmit and receive antenna 209 (ANT). Antenna 209 is, for example, an element comprised in device 102. Antenna 209 is, for example, configured to transmit and receive the electromagnetic field (EMF).

As an example, reader device 104 is further configured to enter the so-called “polling” mode. According to the “polling” mode, device 104 cuts off its field between one or a plurality of polling frames to decrease the power consumption. For example, reader device 104 is configured to cut off its field between several frames when it supports several standards such as the NFC-A, NFC-B, NFC-F, or NFC-V types. The transmission periods between two interrupts are, for example, in the range from 0.5 to 1 s. The field emission duration is, for example, in the order of a few ms, for example 7 ms, when device 104 supports a single standard only. The field emission duration is in the order of several tens of ms, for example between 60 and 80 ms, when reader device 104 supports the four standards NFC-A, NFC-B, NFC-F, and NFC-V.

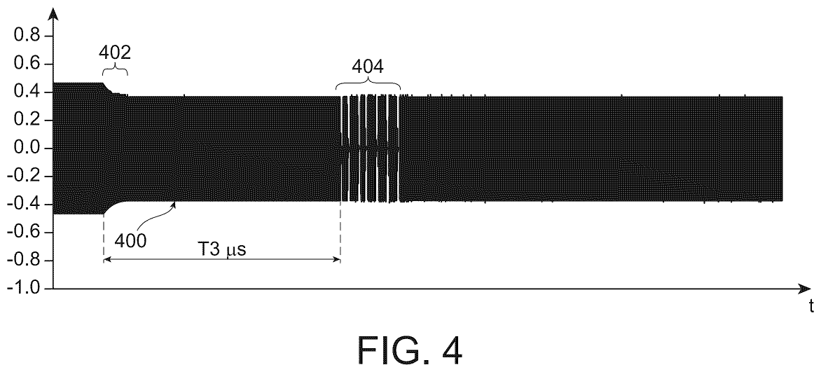

FIG. 3A is a timing diagram 300 illustrating an example of a frame start pattern 302, transmitted by a reader device, for example by reader device 104. In particular, the shown frame start pattern 302 corresponds to a pattern transmitted by a reader device transmitting according to a standard using a 100% modulation. As an example, pattern 302 corresponds to the frame start pattern specific to the NFC-A standard, also referred to herein as type-A communications, and well known to those skilled in the art.

Pattern 302 corresponds to a signal, for example at 13.56 MHz, comprising a pause time T1 preceded by a modulation edge and followed by a demodulation edge. During this pause time, the amplitude of the signal is decreased to zero or close to zero, corresponding, for example, to an amplitude equal to or smaller than 5 percent of the amplitude of the signal outside pause time T1. As an example, for a communication according to the NFC-A standard, pause time T1 is in the range from 2 μs to 3 μs inclusive.

FIG. 3B is a timing diagram 304 illustrating an example of a frame start pattern 306, transmitted by a reader device, for example by reader device 104. In particular, the shown frame start pattern 306 corresponds to a pattern transmitted by a reader device transmitting according to a standard using a 10% modulation. As an example, pattern 306 corresponds to the frame start pattern specific to the NFC-B standard or to the NFC-F standard, also referred to herein as type-B communications and type-F communications, and well known to those skilled in the art.

Pattern 306 corresponds to a signal, for example at 13.56 MHz, comprising a pause time T2 preceded by a modulation edge and followed by a demodulation edge. During this pause time, the signal amplitude is decreased by 10%. As an example, for a communication according to the NFC-F standard, pause time T2 is in the range from 2.3 μs to 2.4 μs inclusive for a transfer rate of 212 kilobits per second, and from 1.1 μs to 1.2 μs inclusive for a transfer rate of 424 kilobits per second.

In the example where pattern 306 corresponds to that transmitted during a communication according to the NFC-B standard, time T2 is in the range from 94 μs to 104 μs inclusive.

The pause time associated with the frame start pattern of the NFC-B standard thus has a duration much longer than the duration of the pause times of the frame start patterns associated with the NFC-A and NFC-F standard. In the case where the device in card emulation mode is configured to emulate cards according to different standards, in particular the NFC-A and NFC-B standards, this difference in the order of pause times may lead to detection faults. Indeed, generally, devices in card mode or emulating a card mode are configured to detect communications issued according to a plurality of standards. As an example, when a modulation edge is detected by the field detector of the device, a processor controls a counter so as to time the pause time between the modulation edge and a demodulation edge. As an example, the processor is configured to determine the standard used according to the timed duration. As an example, as a result of the detection of a first modulation edge, the field detector, or the processor, is configured to ignore another modulation edge which is directly consecutive thereto. As an example, the field detector is further configured to detect a modulation edge again, if no demodulation edge has occurred within the 104 μs following the first modulation edge. In other words, when a modulation edge is detected, the device in card emulation mode is placed in a state of detection of a frame start pattern in which it is configured to only detect frame start patterns characterized by the modulation edge, a pause time, and a demodulation edge. The device in card emulation mode is configured to exit this state when a pattern is detected, or if no pattern is detected, 104 μs after the detection of the modulation edge.

Thus, in the case where the device in card emulation mode detects a first demodulation edge, it waits for 104 μs before determining whether this first edge corresponds to a pattern according to the NFC-B standard. If the first demodulation edge is not followed by a demodulation edge, then the detected modulation edge did not correspond to an NFC-B pattern. The device in card emulation mode is configured to wait for the demodulation edge, it is possible for patterns according to another standard, for example according to the NFC-A or NFC-F standard, to have been transmitted during these 104 μs and not to have been detected.

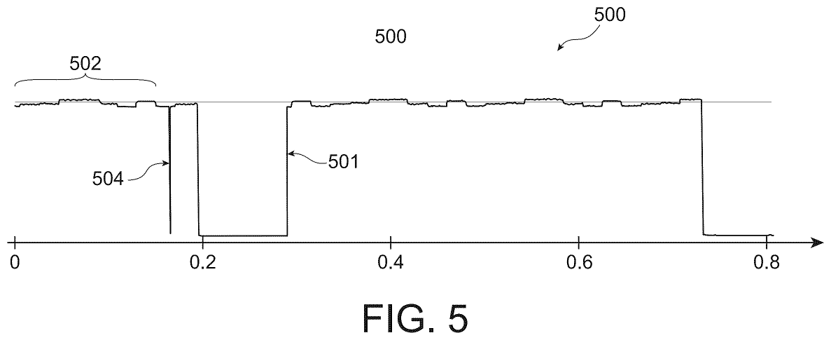

FIG. 4 is a timing diagram illustrating an example in which a detection of a reader device is missed. In particular, the timing diagram shown in FIG. 4 illustrates an example of a signal 400 transmitted by reader device 104. Signal 400 comprises a modulation edge 402 inducing a modulation of the amplitude of signal 400. As an example, the signal amplitude is decreased by 10%. A device in card emulation mode and within range detects this modulation edge and then waits for a demodulation edge to determine the standard used. As a result of the detection of modulation edge 402, the device in card emulation mode is placed in the pattern detection state.

However, the modulation edge 402 of signal 400 does not correspond to a frame start pattern. As an example, modulation edge 402 simply corresponds to an amplitude modulation of the signal. As an example, signal 400 further comprises a succession 404 of frame start patterns. As an example, the succession 404 of patterns comprises six frame start patterns 302. Succession 404 then corresponds, for example, to a request transmitted according to the NFC-A standard. As an example, the transmission of pattern succession 404 is performed T3 μs after modulation edge 402, T3 being smaller than 104 μs. The device in card emulation mode being placed in the pattern detection state, it ignores succession 404 and misses the communication initiated according to the NFC-A standard.

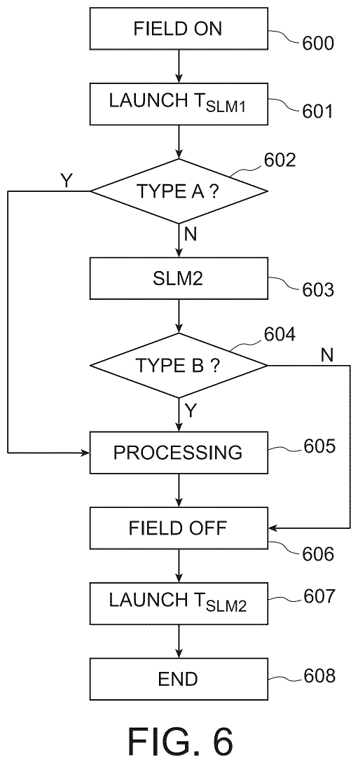

FIG. 5 is a timing diagram 500 illustrating a signal 500 transmitted by a reader device. In particular, signal 500 comprises interferences 502 interfering in a detection method. As an example, interferences 502 induce amplitude variations of signal 500. The amplitude variations caused by interferences are, for example, in the order of 5%. However, in certain cases, the field detector of a device in card emulation mode within range detects in interferences 502a a modulation edge. The device in card emulation mode is then placed in the detection state and waits to detect a demodulation edge. In this example, the device in card emulation mode does not detect a modulation edge 504 transmitted by the reader device to initiate a communication according to, for example, the NFC-A standard.

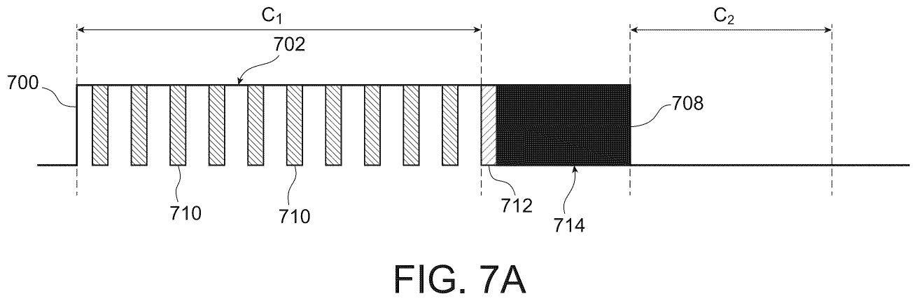

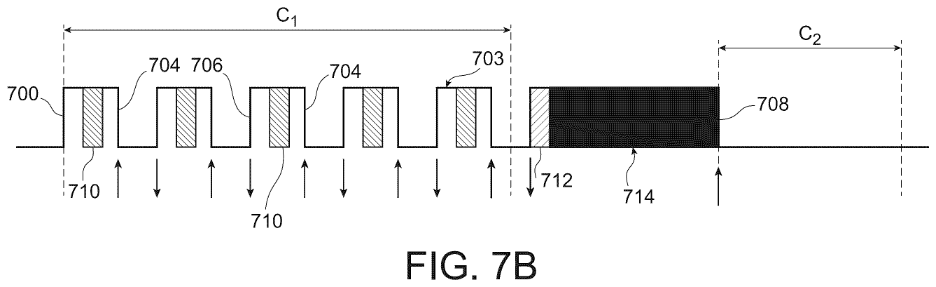

Embodiments overcoming the disadvantages due to this discord between the various NFC standards are described hereafter, in relation with FIGS. 6, 7A, and 7B.

FIG. 6 is a flowchart representing steps in a method of detecting a reader device, for example reader device 104. In particular, the method is implemented by the device in card emulation mode 102.

FIGS. 7A and 7B are timing diagrams illustrating two examples of detection of reader device 104, by the device in card emulation mode 102. In particular, FIGS. 7A and 7B illustrate examples of embodiment of the method described in relation with FIG. 6.

In the examples described in FIGS. 6, 7A, and 7B, the detection of the presence of a field causes a rising edge in the signal transmitted by field detector 203, for example to computing unit 201. Similarly, the end of the detection of a field by the field detector 203 causes a falling edge in the signal transmitted by field detector 203. It may of course be envisaged for the detection of the presence of a field by the detector 203 to result in a falling edge of the detection signal and for the end of detection of a field by the detector 203 or the deactivation of field detector 203 to result in a rising edge in the detection signal. Those skilled in the art will be capable of adapting the method described in relation with FIG. 6 to this variant.

In a step 600 (FIELD ON), the field detector 203 of device 102 is activated and detects the presence of a field emitted by device 104. This detection by field detector 203 causes a first rising edge 700 in the detection signal 702, or 703, transmitted by field detector 203 to computing entity 201. According to an embodiment, device 102 is configured to be placed in a first detection state upon activation of the detection signal by field detector 203. In particular, when it is placed in the first detection state, device 102 is configured to ignore requests issued, by reader device 104, according to one or a plurality of standards, for example according to the NFC-B standard. Generally, when it is placed in the first detection state, device 102 is configured to ignore communications issued according to the standard for which the pause time in the frame start pattern is the longest among the standards recognized by device 102. As an example, the selection of a standard to be detected or the ignoring of a standard is implemented by computing entity 201. As an example, computing entity 201 is configured to deactivate the emulation of the card mode associated with the ignored standard. In another example, computing entity 201 is configured to retrigger the detection of a modulation edge when, after a period of time shorter than the pause time of the ignored standard, no pattern has been detected. As an example, when it is placed in the first detection state, device 102 is configured to detect only communications issued according to the NFC-A standard. In another example, when it is placed in the first detection state, device 102 is configured to only detect communications issued according to the NFC-A and NFC-F standards.

At a step 601 (LAUNCH T_{SLM1}), the first counter 205_1 is started. According to an embodiment, the first counter 205_1 is started after the rising edge 700 occurring during a first activation of field detector 203. The starting of the first counter 205_1, during step 601, causes the placing of device 102 in the first detection state.

At a step 602 (TYPE A?), circuit 106 is configured to determine whether, during a first time period C1, a communication according to a standard recognized by the first detection state is initiated. As an example, the first time period is reached when the first counter 205_1 reaches a first threshold value. As an example, the first time period C1 is equal to 100 ms. In other examples, the first time period is in the range from 50 to 500 ms inclusive.

In the case where circuit 106 does not detect any communication according to a standard recognized by the first detection state (branch N) during the first time period C1, the method continues in a step 603 (SLM2). During the carrying out of step 603, circuit 106 is configured to be switched to a second detection state. As an example, when the first counter 205_1 reaches the first threshold value, computing entity 201 is configured to automatically switch circuit 106 to the second detection state. When it is placed in the second detection state, circuit 106 is configured to detect at least one standard ignored in the first detection state. As an example, when it is placed in the second detection state, circuit 106 is further configured to ignore one or a plurality of states recognized by the first state. For example, in the second detection state, the NFC-B standard is recognized and the NFC-A and NFC-F standards are ignored. In another example, in the second detection state, the NFC-B and NFC-F standards are recognized and the NFC-A standard is ignored. In another example, in the second detection state, the NFC-A, NFC-B, and NFC-F standards are all three recognized.

In a step 604 (TYPE B?), following a carrying out of step 603, circuit 106 is configured to determine whether a communication according to a standard recognized by the second detection state is initiated.

In cases where, when carrying out steps 602 or 604, a communication according to a recognized standard is initiated by device 104 (Y branch at the output of block 602 or at the output of block 604), devices 102 and 104 are coupled, for example, and a transaction is performed in a step 605 (PROCESSING). As an example, the transaction corresponds to a data transfer, to an authentication, to the unlocking of an electronic lock, etc.

When the transaction is completed, the field emitted by device 104 and detected by field detector 203 is deactivated at a step 606 (FIELD OFF). This deactivation results, for example, in a falling edge 708 in signal 702 or 703.

As an example, step 606 follows step 604 in the case where no communication is detected, for example before the expiry of a reference time, for example in the order of one millisecond or of one second, following the first rising edge 700.

The deactivation of the detection signal causes, at a step 607 (LAUNCH T_{SLM2}), the starting of a second counter 205_2. At step 607, circuit 106 is still placed in the second detection state. As an example, circuit 106 is configured to remain in the second state, during step 607, for a second time period C2. As an example, time period C2 expires when the second counter 205_2 reaches a second threshold value. As an example, the second threshold value is equal to 500 ms. In another example, the second threshold value is a value in the range from 100 ms to 1 s.

The circuit 106 of device 102 is, for example, further configured to activate the second counter 205_2 at each falling edge of detection signal 702 or 703. Circuit 106 is further configured to, for example, deactivate the second counter 205_2 at each rising edge of detection signal 702 or 703. Thus, the second counter 205_2 is, for example, started during polling cycles of reader device 104, and in particular during periods when the field emitted by reader device 104 is cut off. As an example, circuit 106 is further configured to reset the second counter 205_2 each time the latter is stopped, in other words, at each rising edge of signal 702 or 703.

When the second counter 205_2 reaches the second threshold value, the method ends at a step 608 (END). Circuit 106 is, for example, configured to perform a new detection, by resuming the method from step 600. As an example, when the second counter 205_2 reaches the second threshold value, communication circuit 106 is switched back to the first detection state. In another example, communication circuit 106 is, for example, switched to another state in which other standards are recognized and at least one standard recognized by the second state is ignored. As an example, the first detection state only recognizes the NFC-A standard, the second detection state only recognizes the NFC-B standard, and the other state only recognizes the NFC-A and NFC-F standards, or only the NFC-F standard.

FIG. 7A illustrates an example of embodiment in which reader device 104 does not cut off its field between polling frames. FIG. 7B illustrates an example of embodiment in which reader device 104 cuts off its field between polling frames in order to decrease its power consumption.

As an example, during the first rising edge 700 of signals 702 and 703 caused by the activation of field detector 203 and the presence of a field, the first counter 205_1 is activated and circuit 106 is in the first detection state.

As an example, requests 710 are transmitted by reader device 104, according to one or a plurality of standards ignored by the first detection state. The circuit 106 of the device in card emulation mode 102, being in the first detection state, the latter does not respond to these requests 710 transmitted according to the first standard. As an example, requests 710 correspond to requests issued according to the NFC-B standard.

In the example shown in FIG. 7B, a succession of falling edges 704 and of rising edges 706, illustrated in FIG. 7B, is caused, for example, by reader device 104 when the latter is in so-called polling mode and polls periodically by activating its field and then deactivating it once the polling frames have been transmitted. Field detector 203 then detects that reader device 104 is in the so-called polling mode. The second counter 205_2 is then started during each period of inactivity of field detector 203. Each starting of the second counter is symbolized in FIG. 7B by an upward arrow, and each stopping of the second counter at the end of these periods of inactivity is symbolized by a downward arrow. As an example, during periods of inactivity, circuit 106 is automatically placed in the second detection state. The first counter 205_1 is configured to continue operating normally, even when field detector 203 no longer detects a field. In other words, when the first counter 205_1 is started, an edge change in the emitted field is not sufficient to stop it. As an example, the first counter 205_1 is only configured to be stopped when it reaches the first threshold value, or when detector 203 detects a pattern corresponding to a standard recognized by the first detection state.

When the first counter reaches the first threshold value, circuit 106 is automatically switched to the second detection state. In the example shown in FIG. 7B, the first counter 205_1 reaches the first threshold value during a period of inactivity of field detector 203. In this example, circuit 106 has already switched to the second detection state.

Device 104 transmits, for example, a new request 712 according to the first standard, for example according to the same standard as requests 710. Circuit 106 being in the second state, it responds to this request, for example by initiating a step of response to device 104. In an example, a transaction, or communication, 714 takes place between devices 102 and 104. In another example, the transaction, or the communication, fails. Once the communication, or transaction, is completed, successfully or not, field detector 203 is deactivated, which is reflected by falling edge 708 in the signal transmitted by detector 203. The second counter 205_2 is then started. When the second counter 205_2 reaches the second threshold value, circuit 106 is, for example, automatically switched back to the first detection state. The second counter 205_2 enables to control the standards detected during field interruption periods in the case where reader device 104 is in so-called “polling” mode, such as illustrated in FIG. 7B. One or a plurality of standards are ignored, or not detected, during the activity time of the first counter 205_1. Device 102 is then configured to detect these standards if no communication has been detected during the first time period C1, counted by first counter 205_1. Circuit 106 then enters the second detection state, and on expiry of the first time period C1, or upon cutting off of a field in a communication with reader device 104, the second counter 205_2 is activated. When the second counter 205_2 expires, by reaching for example the second threshold value, the standards recognized in the second detection state are, for example, ignored again.

The first counter 205_1 is, for example, started or activated by the first field detection corresponding to rising edge 700. Device 102 is then configured to be placed, for example, in the first detection state, in which it ignores at least one communication standard. In the case where no communication is detected during the time period C1 of activity of the first counter 205_1, device 102 switches to the second detection state and the detection of the standard(s), previously ignored, becomes possible. However, leaving device 102 in the second detection state for too long a period could be problematic in certain cases. Indeed, device 102 would risk missing again communications according to, for example, the NFC-A or NFC-F standard. However, it is, for example, not possible to return to the first detection state immediately after the first field extinction detection corresponding to falling edge 708. Indeed, in the case where a communication error happens, reader device 104 can cut off its field for a few milliseconds in order to reset the communication. Time period C2 is then such that device 102 remains, for example, in the second detection state. In another example, if the user prematurely removes device 102, or if it keeps it away, a field interruption occurs. This interruption corresponds, for example, to falling edge 708. However, the transaction is not completed and will resume when the user brings device 102 closer. Device 102 is thus configured, for example, to remain in the second detection state when a transaction is interrupted. In still another example, certain reader devices are configured to detect the withdrawal of a card device. For this purpose, these reader devices return to the interrogation mode, and in some cases to the “polling” mode. In this case, device 102 is, for example, configured to remain in the second detection state in order to respond to these interrogations.

An advantage of the described embodiments is that they enable to detect a specific technology for a time period C1 counted by the first counter 205_1, and then reactivate the detection of this technology at the end of a time period C2 counted by the second counter 205_2 in the case where no technology has been detected for time period C1.

An advantage of the described embodiments is that they enable to first target the detection of an NFC-A request, and then switch to the detection of an NFC-B request, which is advantageous insofar as the NFC-B standard and the NFC-A standard are generally used for the same type of transaction. The NFC-A detection is performed, for example, during a relatively short time interval, for example in the order of 100 μs, which corresponds to the pause time in the NFC-B pattern. If no NFC-A request is detected, the circuit concentrates on the detection of NFC-B requests. The time spent waiting for an NFC-A request is then negligible as compared with the time required for NFC-B detection.

Another advantage of the described embodiments is that the implementation of the method is entirely hardware-based and managed by detection circuit 106. As compared with a software implementation, for example managed by device 102 via a digital tool, the described embodiments have the advantage of being faster.

Another advantage of the described embodiments is that they enable device 102 to avoid missing a transaction, which would be particularly prejudicial in cases where the transaction between the two devices is a banking transaction, an access control verification, or a transport card validation.

Various embodiments and variants have been described. Those skilled in the art will understand that certain features of these various embodiments and variants may be combined, and other variants will occur to those skilled in the art. In particular, with regard to the standards recognized or not in the first and second states, although the NFC-A, NFC-B, and NFC-F standards have mainly been described in the disclosure, those skilled in the art will be capable of adapting to recognize and/or ignore other standards.

Finally, the practical implementation of the described embodiments and variants is within the abilities of those skilled in the art based on the functional indications given hereabove, in particular with regard to the implementation of the first and second counters 205_1 and 205_2. Indeed, it is possible for the first and second counters 205_1 and 205_2 to be two distinct counters of the device 102, or more particularly of communication circuit 106. It is also possible for the first and second counters 205_1 and 205_2 to be one and the same counter. In this case, computing unit 201 is for example configured to apply one or the other of the first and second threshold times to the counter.

1. A method, comprising:
activating a detection signal by a field detector of a near-field communication (NFC) circuit operating in card emulation mode, where the near-field communication circuit is in a first state configured to recognize one or a plurality of communications issued according to a first NFC standard;
starting a first counter of the NFC circuit in response to activating the detection signal; and
when the first counter reaches a first threshold value, switching the NFC circuit to a second state configured to recognize one or a plurality of communications issued according to a second NFC standard;
wherein the NFC circuit, when in the first state, is configured to ignore communications issued according to the second NFC standard.

2. The method according to claim 1, wherein starting the first counter comprises starting on a first rising edge of the detection signal transmitted at the starting of the field detector.

3. The method according to claim 1, further comprising, after switching the NFC circuit to the second state:
starting a second counter; and
when the second counter reaches a second threshold value, switching the NFC circuit to one of the first state or a third state where the NFC circuit is configured to ignore communications issued according to the second NFC standard.

4. The method according to claim 3, wherein starting the second counter comprises starting on a first falling edge of the detection signal transmitted by the field detector.

5. The method according to claim 3, further comprising stopping the second counter and resetting on each rising edge of the detection signal transmitted by the field detector.

6. The method according to claim 1, wherein communications issued according to the first NFC standard are near-field communications of NFC-A type.

7. The method according to claim 1, wherein communications issued according to the second NFC standard are near-field communications of NFC-B type.

8. The method according to claim 1, wherein the NFC circuit is further configured, when placed in the first state, to detect near-field communications of NFC-F type.

9. The method according to claim 1, wherein, where operating in card emulation mode, the NFC circuit is configured to emulate a plurality of cards.

10. A near-field communication (NFC) circuit, comprising:
a field detector;
where the NFC circuit is operating in card emulation mode and is placed in a first state in response to activation of a detection signal generated by the field detector;
where the NFC circuit is configured, when placed in the first state, to detect one or a plurality of communications issued according to a first NFC standard; and
a first counter configured to be started in response to activation of the detection signal;
wherein the NFC circuit is placed in a second state when the first counter reaches a first threshold value;
wherein the NFC circuit is further configured, when placed in the second state, to detect one or a plurality of communications issued according to a second NFC standard; and
wherein the NFC circuit, when placed in the first state, is configured to ignore communications issued according to the second NFC standard.

11. The NFC circuit according to claim 10, wherein the first counter is started on a first rising edge of the detection signal transmitted at the starting of the field detector.

12. The NFC circuit according to claim 10, further comprising:
a second counter configured to be started after switching the NFC circuit to the second state; and
wherein the NFC circuit is placed in one of the first state or a third state when the second counter reaches a second threshold value; and
wherein the NFC circuit is configured to ignore communications issued according to the second NFC standard when placed in either the first state or the third state.

13. The NFC circuit according to claim 12, wherein the second counter is started on a first falling edge of the detection signal transmitted by the field detector.

14. The NFC circuit according to claim 12, wherein the second counter is stopped and reset on each rising edge of the signal transmitted by the field detector.

15. The NFC circuit according to claim 10, wherein communications issued according to the first standard are near-field communications of NFC-A type.

16. The NFC circuit according to claim 10, wherein communications issued according to the second standard are near-field communications of NFC-B type.

17. The NFC circuit according to claim 10, wherein, where operating in card emulation mode, the NFC circuit is configured to emulate a plurality of cards.
